(19) United States
(12) Patent Application Publication
(10) Pub. No.: US 2025/0094246 A1
(43) Pub. Date: Mar. 20, 2025

(54) Metadata-Driven Rapid Adapter Building

(71) Applicant: Oracle International Corporation, Redwood Shores, CA (US)

(72) Inventors: Tuck Chang, Santa Clara, CA (US); Ravi Sankaran, Union City, CA (US); Srimant Misra, Varthur (IN); Ankur Prakash, Banagalore (IN); Zhengming Zhang, Ontario (CA); Anuj Kaushal, Noida (IN); Sagar Shirguppi, Bangalore (IN); Sumit Aneja, Haridwar (IN); Tian Ma, Richmond (CA); Paul Lan, Missouri City, TX (US)

(73) Assignee: Oracle International Corporation, Redwood Shores, CA (US)

(21) Appl. No.: 18/612,994

(22) Filed: Mar. 21, 2024

Related U.S. Application Data
(60) Provisional application No. 63/582,953, filed on Sep. 15, 2023.

(51) Int. Cl. G06F 9/54

(52) U.S. Cl. CPC G06F 9/541

(57) ABSTRACT

Techniques for metadata-driven rapid adapter building (RAB) are disclosed, including: receiving, by an RAB framework, a function call from a third-party application; obtaining, by the RAB framework, a metadata document that defines an adapter between a server-side runtime and the third-party application; determining that the metadata document includes one or more metadata fields that map the function call to one or more software development kit (SDK) functions exposed by the server-side runtime; responsive to receiving the function call and based on the one or more metadata fields, executing the one or more SDK functions exposed by the server-side runtime.

The following application is hereby incorporated by reference: Application No. 63/582,953 filed on Sep. 15, 2023. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to software development. In particular, the present disclosure relates to developing software adapters.

### BACKGROUND

A software development kit (SDK) is a collection of software tools, libraries, documentation, and resources that developers use to create applications, software, and/or services for a specific platform, framework, or programming language. An SDK provides a set of pre-built functionalities, APIs (Application Programming Interfaces), and tools that help developers streamline the development process, reduce the amount of code they need to write from scratch, and ensure compatibility with the target platform. APIs provide access points to the pre-built functionalities and define how different software components should interact with each other. Developers can use APIs to access and utilize various features of the platform or framework.

Typically, functionality outside of that exposed by an SDK must be coded independently. However, in some environments, the ability to introduce new code is restricted or even prohibited. For example, in cloud computing environments that include resources shared among multiple tenants, third-party code is considered untrusted because it was not developed by the entity hosting the shared environment and may include malicious and/or malformed code. Malicious and/or malformed code may present a security risk. For example, malicious code may attempt to access restricted resources, such as administrative functions and/or another tenant's resources. In addition, malicious and/or malformed code may negatively impact system performance, sometimes to the point of rendering the system inoperable. For example, malformed code may execute an infinite loop that consumes additional system resources (e.g., processor cycles, memory, storage, etc.) on each iteration, until all available resources have been consumed. Many kinds of malicious and/or malformed code exist.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment and mean at least one. In the drawings:

FIG. 1 illustrates a system in accordance with one or more embodiments;

FIG. 2 illustrates a system in accordance with one or more embodiments;

FIGS. 3A-3B illustrate an example set of operations for metadata-driven rapid application building in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form, in order to avoid unnecessarily obscuring the present invention.
1. GENERAL OVERVIEW
2. EXAMPLE SYSTEM
2.1. SYSTEM COMPONENTS
2.2. DATA STORAGE
2.3. USER INTERFACE
2.4. TENANTS
2.5. MACHINE LEARNING
3. RAB FRAMEWORK
3.1. EXAMPLE SYSTEM
3.2. EXAMPLE RAB ENGINE
4. METADATA-DRIVEN RAPID APPLICATION BUILDING
4. EXAMPLE METADATA DOCUMENT
5. EXAMPLE METADATA SCHEMA
6. COMPUTER NETWORKS AND CLOUD NETWORKS
7. MICROSERVICE APPLICATIONS
7.1. TRIGGERS
7.2. ACTIONS
8. HARDWARE OVERVIEW
9. MISCELLANEOUS; EXTENSIONS

### 1. General Overview

One or more embodiments include a rapid adapter building (RAB) framework that permits the development of SDK adapters while reducing or eliminating the security and/or performance risks associated with the introduction of untrusted third-party code. As used herein, an adapter is a set of custom code that extends or overrides certain interfaces, defined by an SDK, with code that implements the adapter's behaviors. Techniques described herein reduce or eliminate the amount of custom code needed to implement an adapter. The framework supports low-code or no-code versions of constructs like looping, conditional statements, variable assignments, and state transitions. The framework uses a metadata structure that allows adapter developers to express specialized, third-party logic for integrations.

For example, the framework may support one or more of the following, without requiring untrusted third-party code:
Custom, metadata-driven message transformation from a source system's encoding (e.g., XML) to a third-party (“target”) system's encoding (e.g., JavaScript Object Notation (JSON), arvo, protobuff, and/or other kinds of encodings).
Custom logging functionality that overrides built-in logging, for example, to log additional data in support of debugging, metrics emission, performance monitoring, and/or other kinds of log data.
Overriding outbound logic, to reformat outbound messages into a different form or structure that complies with the target system's requirements.
Message marshalling between system orchestration and adapter logic.
Processing inbound event messages into a different form and/or structure that complies with user requirements.
Outbound calls to third-party services via hypertext protocol language (HTTP), simple object access protocol (SOAP), representational state transfer (REST), and/or other protocols and interfaces. Such calls may support secure socket layer (SSL) context formulation, transport layer security (TLS), and/or other security measures.
Authentication scheme support and secure credential management.
Digital signature validation and message authentication customizations.
Artifact generation logic. As used herein, an “artifact” refers to data produced by writing, compiling, and executing code. For example, an artifact may include one or more of: source code; compiled code; an executable file; documentation; design diagrams; test cases and reports; configuration data; logs; deployment packages; and/or other kinds of data.
Endpoint activation.

In an embodiment, the RAB framework functions as a logical wrapper over the SDK. The RAB framework maps extension points to a metadata document, also referred to herein as an “RAB document.” For each extension point, the RAB framework reads the metadata document to determine the implementation of that extension point. The RAB framework uses a metadata language that provides programming constructs using metadata instead of code, thus supporting a no-code or low-code approach to building an adapter. For example, as a metadata language, the RAB framework may use Serverless Workflow, a product of Cloud Native Computing Foundation (CNCF). For ease of discussion, in some examples described herein, the metadata language is referred to as “CNCF.” However, embodiments should not be considered limited only to those that use Serverless Workflow and/or other CNCF products. All references to CNCF herein should be construed as applying, Mutatis mutandis, to other embodiments that use other metadata languages.

As discussed in further detail below, one or more embodiments operate in a microservices architecture, in which a trigger detected by a microservice can cause the microservice to transmit messages and/or actions to other downstream microservices. For example, a trigger may correspond to receiving an event from an external source, such as receiving an email in a particular account and/or that satisfies one or more other predefined criteria. In an embodiment, the RAB framework includes features for receiving such an event, authenticating it, and decoding it for further processing within the microservices architecture.

One or more embodiments described in this Specification and/or recited in the claims may not be included in this General Overview section.

### 2. Example System

### 2.1. System Components

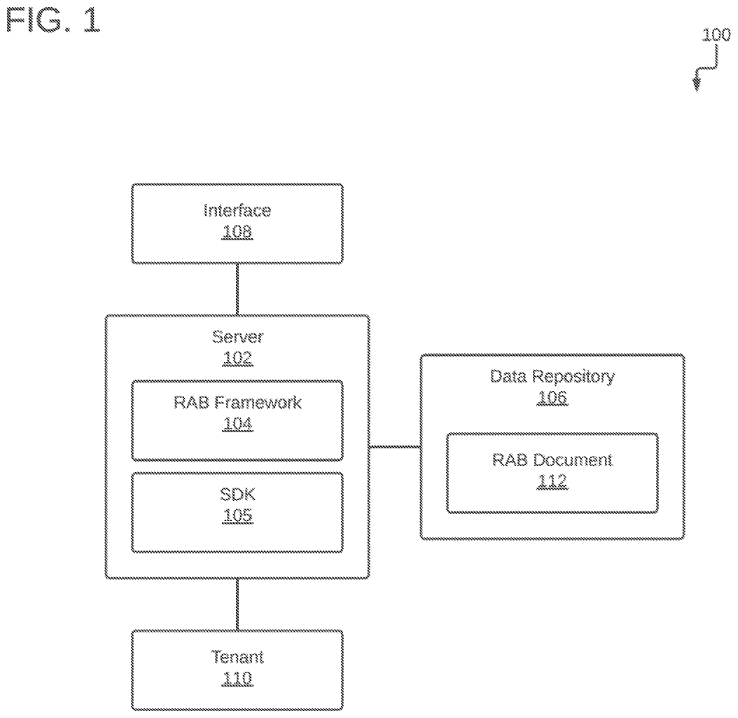

FIG. 1 illustrates an example of a system 100 in accordance with one or more embodiments. As illustrated in FIG. 1, the system 100 includes server 102, data repository 106, interface 108, and one or more tenants 110. Server 102 includes RAB framework 104 and SDK 105. Data repository 106 includes one or more RAB documents 112. Each of these components is described in further detail below.

In an embodiment, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below in the section titled “Computer Networks and Cloud Networks.”

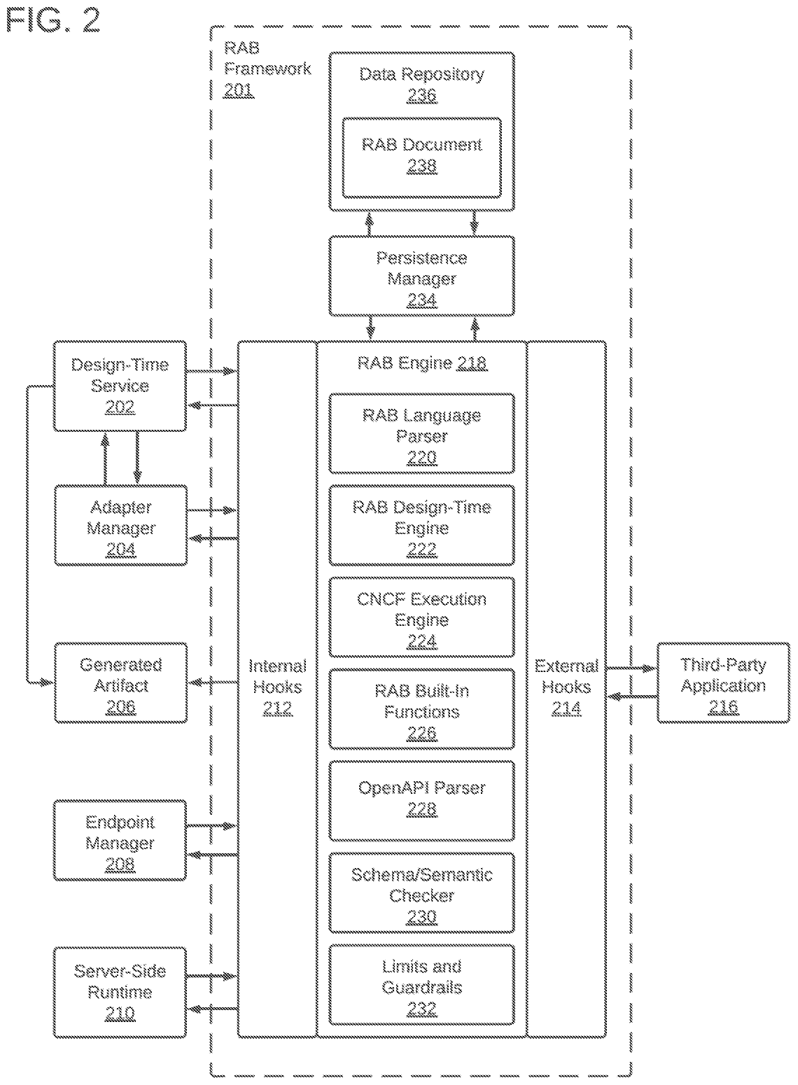

In an embodiment, server 102 refers to hardware and/or software configured to perform operations for metadata-driven rapid adapter building, examples of which are described below. Specifically, server 102 includes RAB framework 104, which functions as a logical wrapper over SDK 105 as described herein. An example of RAB framework 104 is described in further detail below with reference to FIG. 2. RAB framework 104 is configured to use one or more RAB documents 112.

An RAB document 112 is a metadata document that defines an adapter, as described in further detail herein. Specifically, RAB document 112 includes metadata that describes functionality to override one or more SDK functions. RAB document 112 may be an extensible markup language (XML) file, JavaScript object notation (JSON) file, and/or other kind of structured file configured to store metadata. In an embodiment, RAB document 112 includes metadata written to a specification supported by extension hooks provided RAB framework 104. Some examples of extension hooks are described in further detail below.

In an embodiment, one or more components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 2.2. Data Storage

In an embodiment, a data repository 106 is any type of storage unit and/or device (e.g., a file system, database, collection of tables, and/or any other storage mechanism) for storing data. As illustrated in FIG. 1, the data repository 106 may be configured to store one or more RAB documents 112.

The data repository 106 may include multiple different storage units and/or devices. The multiple different storage units and/or devices may or may not be of the same type or located at the same physical site. The data repository 106 may be implemented or executed on the same computing system as RAB framework 102, and/or on a computing system separate from RAB framework 102. The data repository 106 may be communicatively coupled to RAB framework 102 via a direct connection or via a network. Information describing RAB framework 102 may be implemented across any of the components of the system 100. However, this information is illustrated within the data repository 106 for purposes of clarity and explanation.

### 2.3. User Interface

In an embodiment, interface 108 refers to hardware and/or software configured to facilitate communications between a user and RAB Framework 102. Interface 108 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 108 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 108 is specified in one or more other languages, such as Java, Python, C, or C++.

### 2.4. Tenants

In an embodiment, a tenant 110 is a corporation, organization, enterprise, or other entity that accesses a shared computing resource, such as RAB framework 102. The system 100 may include multiple tenants 110 that are independent from each other, such that a business or operation of one tenant is separate from a business or operation of another tenant.

### 2.5. Machine Learning

In an embodiment, a machine learning algorithm is an algorithm that can be iterated to learn a target model that best maps a set of input variables to one or more output variables, using a set of training data. The training data includes datasets and associated labels. The datasets are associated with input variables for the target model. The associated labels are associated with the output variable(s) of the target model. The training data may be updated based on, for example, feedback on the accuracy of the current target model. Updated training data may be fed back into the machine learning algorithm, which may in turn update the target model.

The machine learning algorithm may generate the target model such that the target model best fits the datasets of the training data to the labels of the training data. Specifically, the machine learning algorithm may generate the target model such that when the target model is applied to the datasets of the training data, a maximum number of results determined by the target model match the labels of the training data. Different target models may be generated based on different machine learning algorithms and/or different sets of training data.

The machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

### 3. RAB Framework

As noted above, an RAB framework functions as a logical wrapper over an SDK. The RAB framework translates the extension points provided by the SDK into hooks defined by certain keys in the metadata document. Some of these extensions may be broadly defined (e.g., adapter endpoint configuration pages) while other extensions may be more narrowly defined (for example, outbound overrides). The more narrowly defined extensions allow for overriding portions of the SDK with a relatively narrow contract. For example:
One or more embodiments support configuration pages, accessible through a UI, for configuring adapters. In prior approaches, developers were required to code these pages themselves, including the relationships between the pages and the in-page functionality (e.g., using the Java programming language). These prior approaches allowed developers considerable freedom over page configuration but introduced considerable complexity and required the introduction of custom code. Instead of allowing adapter developers to declare any pages and child pages they like, one or more embodiments define a set collection of pages for adapters to comply with. Some pages may be required and others may be optional, depending on the endpoint configuration functionality required. One or more embodiments may be configured to generate these pages dynamically, without requiring custom coding, based on the relationships between elements defined in the RAB document(s).
For metadata retrieval and binding to UI components for configuration, retrieving metadata from a third party depends on the API exposed. However, in an embodiment, the mapping of the returned values to the UI components is standardized and bound to the UI components with an interface.
Instead of allowing developers to define their own set of settings in a configuration file, in an embodiment, generating a configuration file follows a string contract with some values that support certain specific extensions. For example, a configuration field of a configuration file may model all the selections of the user from the endpoint configuration process according to a specific structure.
For runtime, the metadata adapter may invoke a flow that permits an RAB adapter developer to control the data and the style that would be used to call the third-party endpoint, using CNCF flow and pre-build JQ callable functions exclusively. As used herein, the term “JQ” refers to the JSON processor also known as “./jq.” One or more embodiments may use another metadata processor, and embodiments should not be considered limited to those that use JQ.

In an embodiment, an RAB adapter “engine” can read the metadata document that models an adapter and execute the corresponding instructions according to the model, to drive both design-time configuration and runtime execution. The structure that defines an adapter is expressed in metadata (e.g., JSON metadata). The metadata adapter engine may support extension of certain areas of the template, to permit the adapter developer to customize the behavior using a set of built-in functions and/or through JQ expressions.

In an embodiment, the RAB framework narrowly defines what can be used to extend each of the areas for which extensions are permitted. In this way, the RAB adapter engine functions as a wrapper around the existing adapter SDK, where the existing extension points are redefined to allow only specific patterns and mechanisms for overrides.

Using the adapter SDK, an adapter developer may add custom logic in addition to the standard logic provided by the SDK. The extension points allow the adapter developer to insert their custom logic that makes an adapter specific to the target with which it integrates.

### 3.1. Example System

FIG. 2 illustrates a system 200 in accordance with one or more embodiments. System 200 includes various components, each of which is described in further detail below. In an embodiment, system 200 may include more or fewer components than the components illustrated in FIG. 2. The components illustrated in FIG. 2 may be local to or remote from each other. The components illustrated in FIG. 2 may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below in the section titled “Computer Networks and Cloud Networks.”

In an embodiment, system 200 includes RAB framework 201. RAB framework 201 is configured to perform operations for rapid adapter building (RAB) as described in further detail herein.

In an embodiment, system 200 includes design-time service 202. Design-time service 202 is configured to generate UI elements for configuring adapters. Specifically, one or more embodiments are configured to generate configuration pages dynamically, without requiring custom coding, based on the relationships between elements defined in the RAB document(s).

In an embodiment, system 200 includes adapter manager 204. Adapter manager 204 is configured to satisfy design-time configuration user interface requests, from the design-time server to individual adapter services. In an embodiment, this approach allows the design-time to operate without requiring specific knowledge about particular adapter services.

In an embodiment, system 200 includes one or more generated artifacts 206. A generated artifact 206 refers to a set of artifacts, modeled as configuration and schema files, that capture the user selections and configurations needed for the RAB framework 201 to (1) interpret requests from the server-side runtime 210 and call the corresponding third-party application 216 endpoint(s) and/or (2) interpret requests from third-party application 216 events and translate them to a canonical form that the server-side runtime 210 can process.

In an embodiment, system 200 includes endpoint manager 208. Endpoint manager 208 is configured to stand up endpoints for incoming messages from third-party applications 216, for the server-side runtime 210 to receive messages, relying on generated artifacts 206 for the contract to stand up for ingress of application events.

In an embodiment, system 200 includes server-side runtime 210. Server-side runtime 210 refers to a “live” runtime environment that includes an SDK 211 and is configured to execute functions defined by the SDK 211. RAB framework 201 functions as a logical wrapper around the SDK 211, as described herein. RAB framework 201 allows extension of certain points in the SDK 211, to allow more than simply invoking a third-party endpoint (i.e., more than simply “pass-through” invocations). For example, an RAB developer may add custom logic to handle an inbound message from server-side runtime 210, and format and/or transform the payload into a format that the endpoint expects, which may include different encoding. A CNCF flow that supports this behavior may rely on out-of-the-box functions exposed by RAB framework 201. Many different environments include a server-side runtime 210. For example, Oracle Integration Cloud (OIC) includes a server-side runtime 210.

In an embodiment, RAB framework 201 includes internal hooks 212. Internal hooks 212 are configured to allow developers to customize and/or override default behavior, for an action attached to the respective hook, based on the requirement(s) of a third-party application 216 for an adapter. In an embodiment, internal hooks 212 include one or more of the following. The names assigned to these hooks are for illustrative purposes only and should not be construed as limiting the scope of one or more embodiments:
1. A connection handling processing hook for customizing the requirements of the connection endpoint for the third-party application 216, such as the actual endpoint formulation for an adapter (e.g., the specific protocol needed to communicate with the third-party application 216). In an embodiment, the RAB framework 201 allows the modeling of this customization by using a JSON-based metadata model and dynamically instancing generic code that can drive this behavior.
2. A security policy processing hook for customizing the behavior of an adapter's authentication and authorization to a third-party application 216, which may vary depending on the third-party service. In an embodiment, the RAB framework 201 allows the modeling of this customization by using a JSON-based metadata model and dynamically instancing generic code that can drive this behavior.
3. A user interface metadata engine processing hook for customizing (1) the behavior of generating browser-friendly metadata that can be rendered by a web client into configuration UI components and/or (2) the behaviors between the UI components, based on the metadata model stored on the server for an adapter. In an embodiment, the RAB framework 201 allows the modeling of this customization by using a JSON-based metadata model and dynamically instancing generic code that can drive this behavior.
4. An “artifact generation” hook for customizing the set of files that capture the design-time configuration settings, options, and/or schema definitions defined by the user for the action to be conducted at runtime by the server-side runtime 210. In an embodiment, the RAB framework 201 allows the modeling of this customization by using a JSON based metadata model and dynamically instancing generic code that can drive this behavior.
5. An integration activation processing hook for customizing the preparation needed before making the adapter ready (i.e., “activating” the adapter) to either (1) receive events from the third party application 216 or (2) accept request from the integration process to conduct actions against the third party application 216 based on the desired adapter behavior. In an embodiment, the RAB framework 201 allows the modeling of this customization by using a JSON-based metadata model and dynamically instancing generic code that can drive this behavior.
6. An inbound message receiver processing hook for customizing the processing of the request that is received by the adapter from the third party application 216, based on the desired adapter behavior. In an embodiment, the RAB framework 201 allows the modeling of this customization by using a JSON-based metadata model and dynamically instancing generic code that can drive this behavior.
7. An outbound message handler processing hook for customizing the processing of the request from the integration engine to be conducted on the third-party application 216. In an embodiment, the RAB framework 201 allows the modeling of this customization by using a JSON-based metadata model and dynamically instancing generic code that can drive this behavior.

In an embodiment, RAB framework 201 includes external hooks 214. External hooks 214 are configured to allow an adapter to customize and/or override the default behavior provided by the adapter SDK, to implement the specific behavior desired by an adapter. In an embodiment, external hooks 214 include one or more of the following:
1. An “outbound override” hook for customizing the processing of the request from the integration engine to be conducted on the third-party application 216, as well as the specific requirements of the protocol supported by the third-party endpoint.
2. A “subscription” hook for customizing the requirements of the third-party application 216 for sending events to an adapter, which may include API calls to the third-party application 216 to register for an event.
3. A “security context injection” hook for customizing the authentication and authorization artifact during runtime when making an outbound API call to the third-party application 216, which may vary by third-party applications 216.

In an embodiment, system 200 includes third-party application 216. Third-party application 216 is provided by an entity other than the entity that provides RAB framework 201. In an embodiment, one or more adapters, defined by one or more RAB documents 238, are configured to mediate between server-side runtime 210 and third-party application 216.

In an embodiment, system 200 includes RAB engine 218. RAB engine 218 is configured to perform operations for processing data received via internal hooks 212 and/or external hooks 214. Specifically, RAB engine 218 is configured to process data according to adapter functionality defined in one or more RAB documents 238. Example components of RAB engine 218 in accordance with one or more embodiments are described in further detail below.

In an embodiment, RAB framework 201 includes persistence manager 234. Persistence manager 234 is configured to durably save information into a data store such as a database or object store.

In an embodiment, RAB framework 201 includes a data repository 236 configured to store one or more RAB documents 238. Example embodiments of a data repository 236 and RAB documents 238 are discussed in further detail herein.

### 3.2. Example RAB Engine

In an embodiment, CNCF defines the metadata language that describes various capabilities. RAB engine 218 implements core execution functionality of RAB framework 201, as used in both design-time and runtime. In an embodiment, for design-time, every time a user clicks a UI option that needs to pull data from the third party and display data for user selection, RAB engine 218 executes a CNCF flow bound to the UI component, to retrieve the data. At design-time, responsive to a custom object selection, one or more embodiments execute a CNCF flow bound to the input property, thus driving a dynamic schema based on the custom object selection.

Instead of allowing developers to model individual endpoint configuration pages (e.g., as Java classes) and UI components as object declarations within the pages' definitions (e.g., within Java classes), one or more embodiments drive the instantiation of the objects and the defining of their dependencies through a metadata document (e.g., a JSON document).

In an embodiment, RAB engine 218 includes RAB language parser 220. RAB language parser 220 is configured to interpret the metadata language vocabulary and grammar and create a memory model for the RAB document 238, in a form that can be processed programmatically.

In an embodiment, RAB engine 218 includes RAB design-time engine 222. RAB design-time engine 222 is configured to interpret the design-time portion of the RAB document model, drive the creation of the design UI components and their dependency behaviors with each other, and use them to generate the artifacts 206 that are used during runtime.

In an embodiment, RAB engine 218 includes CNCF execution engine 224. CNCF execution engine 224 is configured to execute the logic of the adapter that is defined in the RAB document 238, which includes executing the series of steps modeled as a series of states in a flow compliant with CNCF serverless workflow, to drive the desired behavior of the adapter.

In an embodiment, RAB engine 218 includes RAB built-in (a.k.a. pre-built) functions 226. RAB built-in functions 226 are configured to provide a set of common functions provided by the RAB framework 201, backed by code constructs that are difficult to model in CNCF, to achieve the processing behavior required of an adapter.

In an embodiment, RAB engine 218 includes OpenAPI parser 228. OpenAPI parser 228 is configured to parse OpenAPI into a memory model that can be transferred and processed the RAB framework 201 in CNCF states.

In an embodiment, RAB engine 218 includes schema/semantic checker 230. Schema/schematic checker 230 is configured to provide the RAB document 238 author a way to check the syntax and semantic validity of the RAB document 238's vocabulary and grammar.

In an embodiment, RAB engine 218 includes limits and guardrails 232. Limits and guardrails 232 are configured to provide checks against RAB metadata document 238 authors from modeling behavior that affect the adapter, the RAB framework 201, or the integration process in an adverse way, whether inadvertently or maliciously, such as infinite looping, data siphoning to unintended destinations, and/or insecure protocol usage.

### 4. Metadata-Driven Rapid Application Building

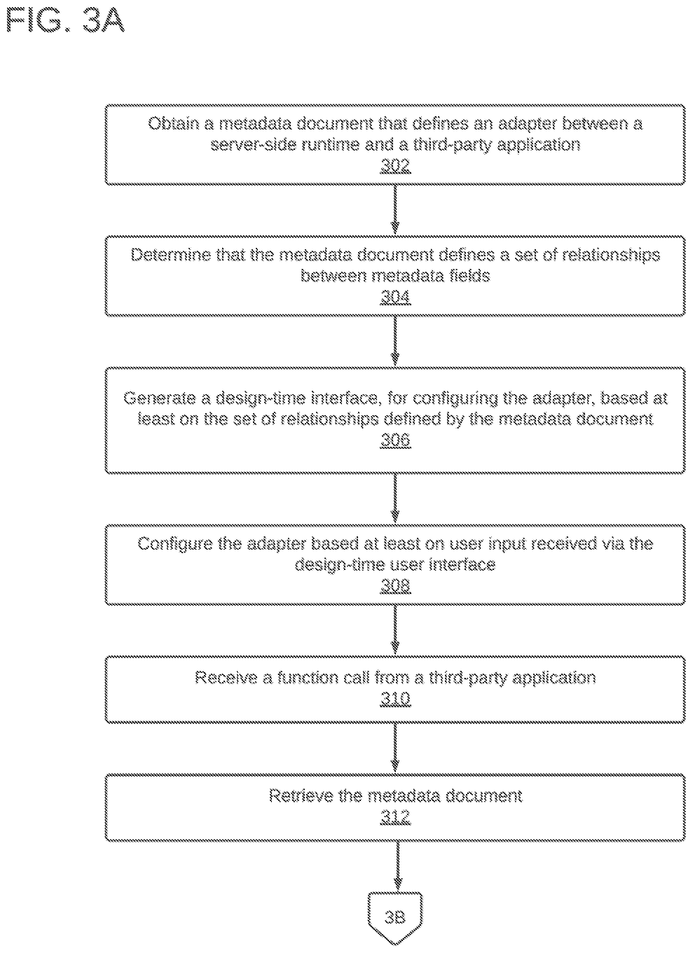

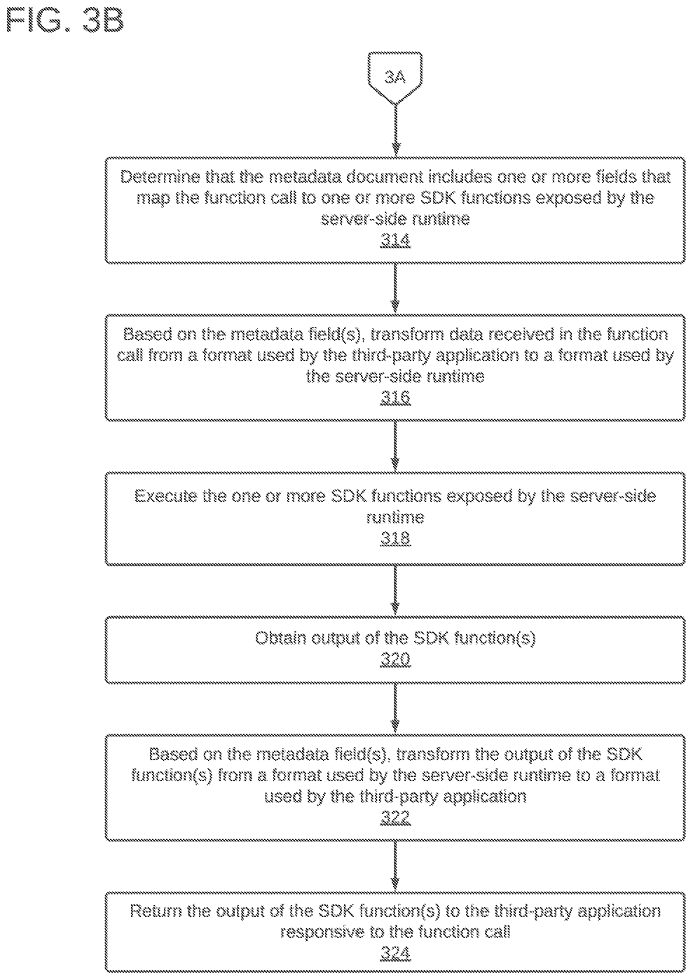

FIGS. 3A-3B illustrates an example set of operations for metadata-driven rapid application building in accordance with one or more embodiments. One or more operations illustrated in FIGS. 3A-3B may be modified, rearranged, or omitted all together. Accordingly, the particular sequence of operations illustrated in FIGS. 3A-3B should not be construed as limiting the scope of one or more embodiments.

In an embodiment, a system (e.g., one or more components of system 100 illustrated in FIG. 1) obtains a metadata document that defines an adapter between a server-side runtime and a third-party application (Operation 302). The metadata document defines the adapter without including any executable and/or compilable code. The system may obtain the metadata document from a data repository, where it may have been stored, for example, by an adapter developer.

In an embodiment, the system determines that the metadata document defines a set of relationships between metadata fields (Operation 304). For example, the metadata document may define logical relationships between individual fields, state transitions, etc. Based at least on the set of relationships defined by the metadata document, the system may generate a design-time interface for configuring the adapter (Operation 306). The system may then configure the adapter, based at least on user input received via the design-time interface (Operation 308).

Once an adapter has been defined and configured, the system may use the adapter at runtime. Specifically, at runtime, the system may receive a function call from a third-party application (Operation 310). The function call may correspond to a hook in an RAB framework (e.g., as described herein). The system may retrieve the metadata document (Operation 312) and determine that the metadata document includes one or more fields that map the function call to one or more SDK functions exposed by the server-side runtime (Operation 314).

In an embodiment, the metadata document defines one or more data transformations applicable to the function call. Based on the metadata field(s), the system may transform data received in the function call from a format used by the third-party application to a format used by the server-side runtime (Operation 316).

In an embodiment, the system executes the one or more functions exposed by the server-side runtime (Operation 318). To execute the function(s), the system may instantiate one or more objects defined in the metadata document fields, using server-side code that was not included in the metadata document. Alternatively or additionally, the system may call one or more endpoints identified by the metadata document fields, even though the metadata document itself does not include any code to call the endpoint(s). Thus, the metadata document includes the information needed to apply the adapter, even though the metadata document itself does not include any executable and/or compilable code.

If an SDK function that was executed as described above produces an output, the system may obtain the output (Operation 320). As noted above, the metadata document may define one or more data transformations applicable to the function call. Based on the metadata field(s), the system may transform the output of the SDK function(s) from a format used by the server-side runtime to a format used by the third-party application (Operation 322). Alternatively or additionally, transforming the output may include enriching the output. For example, the system may obtain log data from another source and add the log data to the output of the SDK function(s).

In an embodiment, the system returns the output of the SDK function(s) to the third-party application, responsive to the function call (Operation 324).

### 4. Example Metadata Document

Appendix A, attached hereto and hereby incorporated by reference in its entirety, describes an example of a metadata document (also referred to as an RAB document) according to one or more embodiments. Specifically, Appendix A is an example of an adapter implemented as a metadata document, using techniques described herein.

Components and/or operations described in Appendix A should be understood as one specific example which may not be applicable to certain embodiments. Accordingly, components and/or operations described in Appendix A should not be construed as limiting the scope of any of the claims.

### 5. Example Metadata Schema

Appendixes B1 through B9, attached hereto and hereby incorporated by reference in its entirety, describe an example of a metadata schema (also referred to as an RAB document schema) according to one or more embodiments. Specifically, Appendixes B1 through B9 are examples of different sections of a schema for implementing adapters using RAB documents, using techniques described herein. For example, the RAB document shown in Appendix A adheres to this schema. One or more embodiments use a metadata schema to validate an RAB document.

Components and/or operations described in Appendixes B1 through B9 should be understood as one specific example which may not be applicable to certain embodiments. Accordingly, components and/or operations described in Appendixes B1 through B9 should not be construed as limiting the scope of any of the claims.

### 5.1. Appendix B1

Appendix B1 is an example of a schema section for “actions,” representing a user-facing list of capabilities of an adapter. This schema section includes information that powers the UI for design-time configuration. For each action, the schema section includes a name, description, configuration options, and schemas for mapping inputs and outputs.

More specifically, in an embodiment, an action models the capabilities of an adapter that are shown to a user at design-time—i.e., which fields, corresponding field labels (which may be localized), interactions, etc. An action may specify a particular category for organizational purposes (e.g., so that a large number of actions can be filtered by category, rather than presented in a monolithic list). The adapter capabilities shown to a user at design-time may be a subset of the adapter's total capabilities. For example, the API contract with a third-party service may specify that a request returns 50 fields. The corresponding action may specify a subset of 20 of those fields to be shown to the user at design-time.

In an embodiment, an action specifies a flow to be called at runtime. For example, the action may include an execute key corresponding to a particular action. At runtime, the system retrieves the metadata stored in the action, including the execute key, and calls the appropriate flow with the appropriate metadata.

### 5.2. Appendix B2

Appendix B2 is an example of a schema section for “categories,” representing a user-facing list of actions/triggers for an adapter. This section includes information that powers the UI for design-time configuration. Specifically, in an embodiment, categories are used to organize actions as described above, to provide a better user experience at design-time.

### 5.3. Appendix B3

Appendix B3 is an example of a schema section for common data types used in the schema. These data types can be used throughout the schema, so that changes to data types propagate from a single location rather than needing to be replicated in each location where that data type is used. In this example, the common data types include: nameString; displayNameString; shortText; longText; urlString; emailString; hostNameString; versionString; dateString; dataTimeString; nonEmptyString; flowPattern; arguemntsJQPattern; flowOrJQExpression; stringOrArgumentJQPattern; stringOrArgumentJQArray; singleOrMultiValuedList; singleOrMultiValuedMap; singleValueMap; httpHeaders; httpBody; and httpResponse. For each common data type, the schema section includes a description, type, one or more properties, and one or more examples. One or more embodiments may include different common data types.

### 5.4. Appendix B4

Appendix B4 is an example of a schema section for a connection definition. Connections facilitate connectivity with external applications and may be divided into (a) how external applications can invoke a local integration and (b) how local code can invoke external applications. Connections may be reusable. One or more embodiments further support a trigger connection, which can be used to securely expose integration flows to external applications. In an embodiment, a connection definition includes a connection name, connection role (e.g., “trigger” or “invoke”), one or more connection properties, and one or more security policies.

More specifically, in an embodiment, a connection definition includes the logic for how to connect to a third-party API, through the authentication/authorization framework supported by that API. Connection properties may provide information about the “location” of a given third-party API endpoint—e.g., the port, domain, agent, etc. needed to reach the endpoint. Security policies may indicate how to authenticate with the endpoint, once the endpoint is reached. For example, one or more embodiments support a set of standards-based authentication schemes (a.k.a. managed policies), such as OAuth, JSON web key (JWK) signing keys, etc.), one of which may be specified for a given connection.

### 5.5. Appendix B5

Appendix B5 is an example of a schema section for flows. In an embodiment, a flow refers to a higher-level function formed by one or more lower-level steps. A flow may operate as a state transition model, where each state (except for the final state) indicates which state to enter next. Which state to enter next may depend on one or more criteria evaluated in the current state. One or more embodiments may execute one or more functions within each state (e.g., third-party calls, data manipulation functions, etc.). For example, one or more embodiments may define flows for returning a list of all mailboxes associated with a particular mail service user, test a connection with a given set of credentials, etc.

### 5.6. Appendix B6

Appendix B6 is an example of a schema section for adapter information. Specifically, this schema section includes basic information for an adapter, such as properties (e.g., title, description, etc.) used by the adapter.

### 5.7. Appendix B7

Appendix B7 is an example of a schema section that references all the subsections of the overall schema specification (referred to here as an ADD specification). Specifically, in an embodiment, a metadata schema can be divided into multiple files, and each subsection may list the corresponding file location.

### 5.8. Appendix B8

Appendix B8 is an example of a schema section for a contract schema. Specifically, in an embodiment, a contract schema describes a user-friendly contract for how data retrieved from a third-party API will appear to the user at design-time. For example, a third-party API may be configured to return data that includes 250 fields, which may include links to child objects. A contract may specify a subset of fields (e.g., 50 fields) that are necessary and/or need to be user-facing at design-time. An action (described in further detail above) may reference a particular contract schema. Alternatively or additionally, an action may embed a contract schema into the Action Itself. Storing Contracts Outside of Actions Allows for Contracts to be Reused without needing to replicate their definitions in each location where they are used.

### 5.9. Appendix B9

Appendix B9 is an example of a schema section for a trigger. A trigger models the ability for an adapter to receive an event from an external source and can be implemented in different ways. In an embodiment, most events will arrive as HTTP requests from one or more external sources, in the form of webhooks. One or more embodiments further support modeling an event using a polling infrastructure.

Specifically, in an embodiment, a trigger models how an adapter receives events. For example, a trigger may specify an endpoint (e.g., an HTTP location) for a third-party service to contact when a given event occurs. A trigger may also include authentication information that the third-party service can use to access that endpoint. Alternatively or additionally, a trigger may specify one or more manipulations to perform on data returned by the third-party service. IF the third-party service's API supports subscribe/unsubscribe functions without requiring manual data entry, a trigger may specify which subscribe function(s) to call when the adapter is activated and/or which unsubscribe function(s) to call when the adapter is deactivated.

### 6. Computer Networks and Cloud Networks

In an embodiment, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service, such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, or a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network, such as a physical network. Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In an embodiment, in a multi-tenant computer network, tenant isolation is implemented to ensure that the applications and/or data of different tenants are not shared with each other. Various tenant isolation approaches may be used.

In an embodiment, each tenant is associated with a tenant identifier (ID). Each network resource of the multi-tenant computer network is tagged with a tenant ID. A tenant is permitted access to a particular network resource only if the tenant and the particular network resources are associated with the same tenant ID.

In an embodiment, each tenant is associated with a tenant ID. Each application, implemented by the computer network, is tagged with a tenant ID. Alternatively or additionally, each data structure and/or dataset, stored by the computer network, is tagged with a tenant ID. A tenant is permitted access to a particular application, data structure, and/or dataset only if the tenant and the particular data structure and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally include a single logical executable. With microservice applications, different microservices are independently deployable as separate executables. Microservices may communicate using HyperText Transfer Protocol (HTTP) messages and/or according to other communication protocols via Application Programming Interface (API) endpoints. Microservices may be managed and updated separately, written in different languages, and may be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or another microservices manager when trigger events from a set of trigger events exposed to the microservices manager occur. Microservices exposed for an application may alternatively or additionally provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In an embodiment, discrete capabilities offered by microservices may be connected via a GUI. A microservice may offer more than one capability. For example, the capabilities of a microservice may be displayed as logical blocks within a window, frame, or other element of a GUI. A user may drag and drop a visual representation of a capability offered by a microservice into an area of the GUI used to build an application. The user may connect the output of one microservice service into the input of another microservice using directed arrows or any other GUI element. The application builder may run verification tests to confirm that the output and inputs are compatible (e.g., by checking the datatypes, size restrictions, etc.)

### 7.1. Triggers

The techniques described above may be encapsulated into a microservice, according to one or more embodiments. In other words, a microservice may trigger a notification (into the microservices manager for optional use by other plugged-in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects that a value has crossed a triggering threshold.

In an embodiment, the trigger, when satisfied, may output data for consumption by the target microservice. In another embodiment, the trigger, when satisfied, outputs a binary value indicating that the trigger has been satisfied, and/or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### 7.2. Actions

In an embodiment, a plugged-in microservice application may expose actions to the microservices manager. The exposed actions may receive, as input, data or an identification of a data object or location of data that causes data to be moved into a data cloud.

In an embodiment, the exposed actions may receive, as input, a request to increase or decrease existing alert thresholds. The input may identify existing in-application alert thresholds and whether to increase, decrease, or delete the threshold. Alternatively or additionally, the input may request the microservice application to create new in-application alert thresholds. The in-application alerts may trigger alerts to the user while logged into the application or may trigger alerts to the user, using default or user-selected alert mechanisms available within the microservice application itself, rather than through other applications plugged into the microservices manager.

In an embodiment, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 8. Hardware Overview

According to one embodiment, the techniques described herein are implemented by one or more special-purpose computing devices. The special-purpose computing device(s) may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices, or any other device that incorporates hard-wired and/or program logic to implement the techniques.

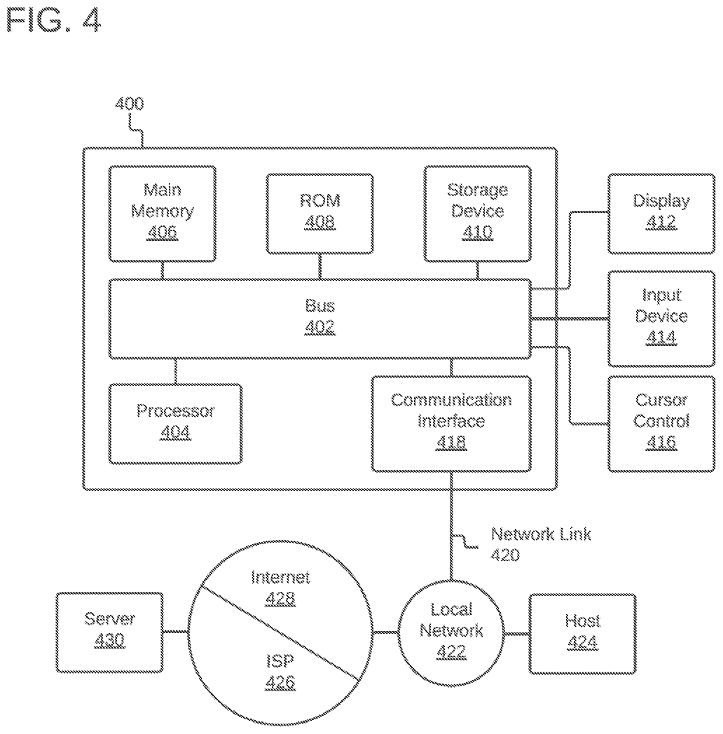

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to the processor 404, render computer system 400 into a special-purpose machine that is customized to perform the operations specified in the instructions.

Computer system 400 further includes a read only memory (ROM) 408 or other static storage device coupled to the bus 402 for storing static information and instructions for the processor 404. A storage device 410, such as a magnetic disk or optical disk, is provided and coupled to the bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware, and/or program logic which in combination with computer system 400 causes or programs computer system 400 to be a special-purpose machine. In an embodiment, the techniques herein are performed by computer system 400 in response to the processor 404 executing one or more sequences of one or more instructions contained in the main memory 406. Such instructions may be read into the main memory 406 from another storage medium, such as the storage device 410. Execution of the sequences of instructions contained in the main memory 406 causes the processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may include non-volatile media and/or volatile media. Non-volatile media includes, for example, optical or magnetic disks, such as storage device 410. Volatile media includes dynamic memory, such as the main memory 406. Common forms of storage media include, for example, a floppy disk, a flexible disk, hard disk, solid state drive, magnetic tape, or any other magnetic data storage medium, a read-only compact disc (CD-ROM), any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires of bus 402. Transmission media can also take the form of acoustic or light waves, such as those generated during radio wave and infrared data communications.

Various forms of media may be involved in carrying one or more sequences of one or more instructions to the processor 404 for execution. For example, the instructions may initially be carried on a magnetic disk or solid-state drive of a remote computer. The remote computer can load the instructions into its dynamic memory and send the instructions over a telephone line or other communications medium, using a modem. A modem local to computer system 400 can receive the data on the telephone line or other communications medium and use an infrared transmitter to convert the data to an infrared signal. An infrared detector can receive the data carried in the infrared signal and appropriate circuitry can place the data on the bus 402. The bus 402 carries the data to the main memory 406, from which the processor 404 retrieves and executes the instructions. The instructions received by the main memory 406 may optionally be stored on the storage device 410, either before or after execution by processor 404.

Computer system 400 also includes a communication interface 418 coupled to the bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card configured to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through a local network 422 to a host computer 424 or to data equipment operated by an Internet Service Provider (ISP) 426. The ISP 426 in turn provides data communication services through the world wide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420, and communication interface 418. In the Internet example, a server 430 might transmit a requested code for an application program through the Internet 428, ISP 426, local network 422, and communication interface 418.

The received code may be executed by processor 404 as it is received, and/or may be stored in the storage device 410 or other non-volatile storage for later execution.

### 9. Miscellaneous; Extensions

Embodiments are directed to a system with one or more devices that include a hardware processor and that are configured to perform any of the operations described herein and/or recited in any of the claims below.

In an embodiment, a non-transitory computer-readable storage medium stores instructions which, when executed by one or more hardware processors, cause performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing instructions which, when executed by one or more hardware processors, cause performance of operations comprising:
receiving, by a rapid adapter building (RAB) framework, a function call from a third-party application;
obtaining, by the RAB framework, a metadata document that defines an adapter between a server-side runtime and the third-party application;
determining that the metadata document comprises one or more metadata fields that map the function call to one or more software development kit (SDK) functions exposed by the server-side runtime;
responsive to receiving the function call and based on the one or more metadata fields, executing the one or more SDK functions exposed by the server-side runtime.

2. The one or more non-transitory computer-readable media of claim 1, the operations further comprising:
determining that the metadata document defines a set of relationships between metadata fields in the metadata document;
generating a design-time user interface, for configuring the adapter, based at least on the set of relationships defined by the metadata document;
configuring the adapter based at least on user input received via the design-time user interface.

3. The one or more non-transitory computer-readable media of claim 1, the operations further comprising:
based on the one or more metadata fields, transforming data received in the function call from (a) a first format used by the third-party application to (b) a second format used by the server-side runtime.

4. The one or more non-transitory computer-readable media of claim 1, the operations further comprising:
obtaining an output of the one or more SDK functions exposed by the server-side runtime;
returning the output to the third-party application responsive to receiving the function call.

5. The one or more non-transitory computer-readable media of claim 4, the operations further comprising:
based on the one or more metadata fields, transforming the output of the one or more SDK functions exposed by the server-side runtime from (a) a first format used by the server-side runtime to (b) a second format used by the third-party application.

6. The one or more non-transitory computer-readable media of claim 4, the operations further comprising:
based on the one or more metadata fields, enriching the output of the one or more SDK functions with additional data not supplied by the one or more SDK functions.

7. The one or more non-transitory computer-readable media of claim 1, wherein the metadata document is a JavaScript Object Notation (JSON) document.

8. A system comprising:
one or more hardware processors;
one or more non-transitory computer-readable media; and
program instructions stored on the one or more non-transitory computer readable media which, when executed by the one or more hardware processors, cause the system to perform operations comprising:
receiving, by a rapid adapter building (RAB) framework, a function call from a third-party application;
obtaining, by the RAB framework, a metadata document that defines an adapter between a server-side runtime and the third-party application;
determining that the metadata document comprises one or more metadata fields that map the function call to one or more software development kit (SDK) functions exposed by the server-side runtime;
responsive to receiving the function call and based on the one or more metadata fields, executing the one or more SDK functions exposed by the server-side runtime.

9. The system of claim 8, the operations further comprising:
determining that the metadata document defines a set of relationships between metadata fields in the metadata document;
generating a design-time user interface, for configuring the adapter, based at least on the set of relationships defined by the metadata document;
configuring the adapter based at least on user input received via the design-time user interface.

10. The system of claim 8, the operations further comprising:
based on the one or more metadata fields, transforming data received in the function call from (a) a first format used by the third-party application to (b) a second format used by the server-side runtime.

11. The system of claim 8, the operations further comprising:
obtaining an output of the one or more SDK functions exposed by the server-side runtime;
returning the output to the third-party application responsive to receiving the function call.

12. The system of claim 11, the operations further comprising:
based on the one or more metadata fields, transforming the output of the one or more SDK functions exposed by the server-side runtime from (a) a first format used by the server-side runtime to (b) a second format used by the third-party application.

13. The system of claim 11, the operations further comprising:
based on the one or more metadata fields, enriching the output of the one or more SDK functions with additional data not supplied by the one or more SDK functions.

14. The system of claim 8, wherein the metadata document is a JavaScript Object Notation (JSON) document.

15. A method comprising:
receiving, by a rapid adapter building (RAB) framework, a function call from a third-party application;
obtaining, by the RAB framework, a metadata document that defines an adapter between a server-side runtime and the third-party application;
determining that the metadata document comprises one or more metadata fields that map the function call to one or more software development kit (SDK) functions exposed by the server-side runtime;
responsive to receiving the function call and based on the one or more metadata fields, executing the one or more SDK functions exposed by the server-side runtime;
wherein the method is performed by at least one device including a hardware processor.

16. The method of claim 15, further comprising:
determining that the metadata document defines a set of relationships between metadata fields in the metadata document;
generating a design-time user interface, for configuring the adapter, based at least on the set of relationships defined by the metadata document;
configuring the adapter based at least on user input received via the design-time user interface.

17. The method of claim 15, further comprising:
based on the one or more metadata fields, transforming data received in the function call from (a) a first format used by the third-party application to (b) a second format used by the server-side runtime.

18. The method of claim 15, further comprising:
obtaining an output of the one or more SDK functions exposed by the server-side runtime;
returning the output to the third-party application responsive to receiving the function call.

19. The method of claim 18, further comprising:
based on the one or more metadata fields, transforming the output of the one or more SDK functions exposed by the server-side runtime from (a) a first format used by the server-side runtime to (b) a second format used by the third-party application.

20. The method of claim 18, further comprising:
based on the one or more metadata fields, enriching the output of the one or more SDK functions with additional data not supplied by the one or more SDK functions.
